(19) United States
(12) Patent Application Publication
(10) Pub. No.: US 2005/0017680 A1
(43) Pub. Date: Jan. 27, 2005

(54) Power source

(76) Inventors: Liguo Zhao, Toledo, OH (US); Terry Potter, Lambertville, MI (US)

Correspondence Address: MARSHALL & MELHORN, FOUR SEAGATE, EIGHT FLOOR, TOLEDO, OH, 43604, US

(21) Appl. No.: 10/887,745

(22) Filed: Jul. 9, 2004

Related U.S. Application Data
(60) Provisional application No. 60/486,040, filed on Jul. 10, 2003.

(51) Int. Cl. H02J 7/00

(52) U.S. Cl. 320/112

(57) ABSTRACT

A power source having at two parallel concave surfaces, preferably connected by a plurality of curvilinear surfaces. A source for electric power is disposed within the concave and curvilinear surfaces.

### RELATED APPLICATION

This application is claiming benefit, under 35 USC § 119(e), of the provisional application filed on Jul. 10, 2003, under 35 USC § 111(b), which was granted Ser. No. 60/486,040, and is hereby incorporated by reference in its entirety.

### FIELD OF THE INVENTION

The present invention relates to power source having at least one concave exterior surface and, more particularly, to such a power source for use with a portable vacuum system.

### BACKGROUND OF THE INVENTION

Portable, battery powered electrically operated devices are well known. For example, it is well known to operate a portable vacuum cleaner with rechargeable batteries to provide the operator with a certain degree of freedom not offered by vacuum cleaners connected to a wall outlet with a cord.

The prior art batteries, however, are awkward and clumsy. They often extend from the electrically powered device, thus increasing its weight and its profile and take up space in the device itself. The prior art designs may also adversely affect the balance of the electrically powered device.

It is also well known for the operator of an electrically powered device to carry the batteries on his or her body. The prior art designs are disadvantageous since they extend outwardly from the operator increasing the risk that the batteries can be bumped, or jarred, in close operating quarters. The prior art batteries worn by operators also may adversely affect their balance, or increase strain on body parts, such as the lower back.

In light of the disadvantages of the prior art, it would be advantageous to have a portable power source that is worn by the operator, that has a low profile, complementary shape to the operator, and that makes wearing the power source relatively comfortable and strain-free.

### SUMMARY OF THE INVENTION

The present invention is directed toward a power source preferably having two parallel concave exterior surfaces. At least one of the concave surfaces is designed to have a complementary shape to the hip area of the operator. A source for electrical power is disposed within the concave exterior surfaces.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a schematic perspective view of an embodiment of the present invention;

FIG. 2 is a schematic perspective view of an alternative embodiment of the present invention;

FIG. 3 is a schematic perspective view of an embodiment of the present invention;

FIG. 4 is a schematic perspective view of an alternative embodiment of the present invention;

FIG. 5 is a schematic perspective view of a component of the alternative embodiment of the present invention; and

FIG. 6 is a schematic perspective view of an alternative embodiment of the present invention.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

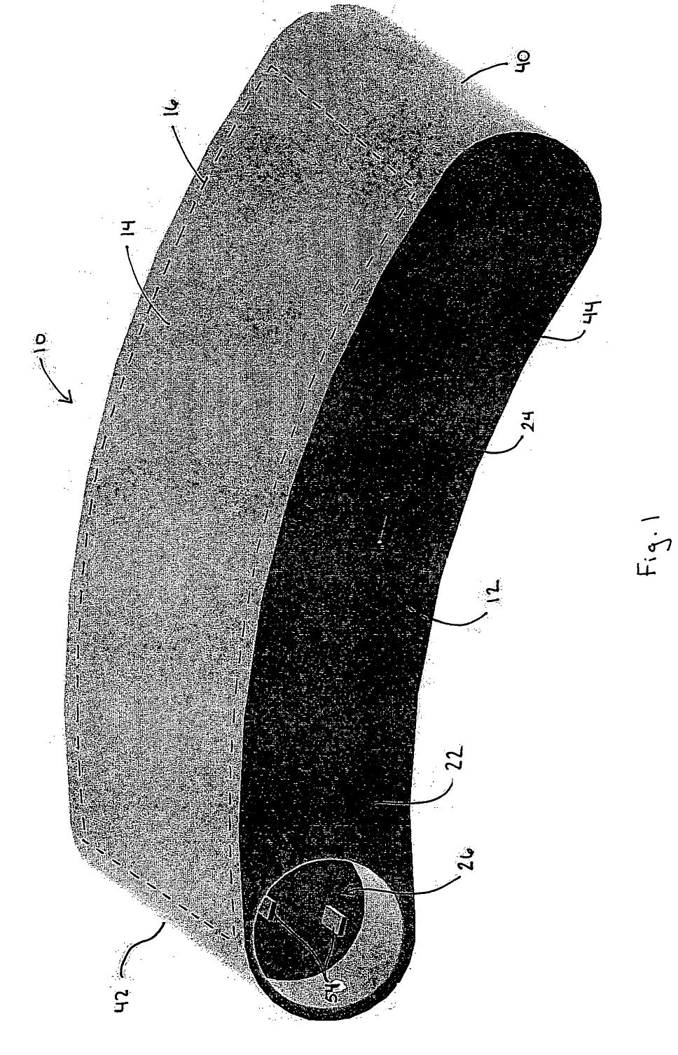

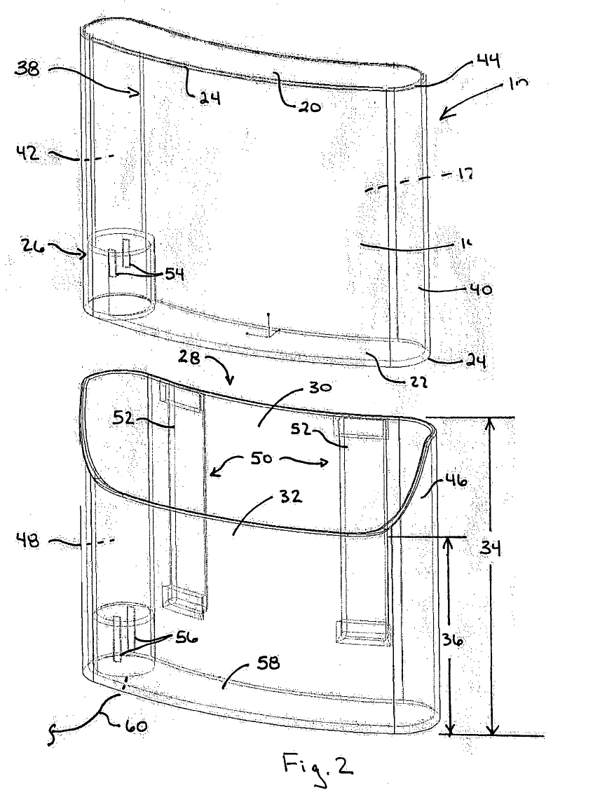

Referring now to FIGS. 1 and 2, a power source 10 having a first curvilinear side 12 and at least a second curvilinear side 14 is depicted. The first and the second curvilinear sides 12, 14 are oriented substantially parallel to, but spaced apart from, one another. Preferably, the entire lengths of the first and second sides 12, 14 are of the same curvilinear shape. The preferred curvilinear shape is concave. This design creates an overall C-shaped design of the power source 10.

In an alternative embodiment (not depicted), at least the first side 12 is C-shaped. The other side 14 may be of any shape or design.

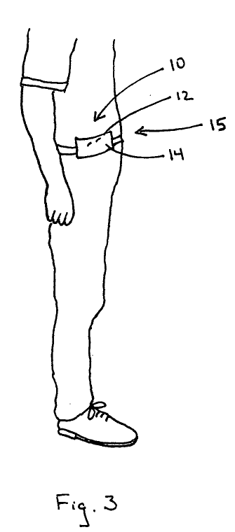

Regardless of the embodiment, it is preferred that at least the first side 12 has a curvilinear shape that complements the hip area 15 of a person, as shown in FIG. 3.

Although a one piece power source 10 is preferred, those skilled in the art will readily appreciate that the power source can 10 be put together by any combination of sections, pieces or components. If a multi-piece power source 10 is used, it is preferred that when the pieces are assembled that they take on the shape and function of the one piece power source 10. A one piece power source 10 will be used to describe the invention hereinafter, but it should be understood that a similarly shaped multi-piece power source 10 can be used.

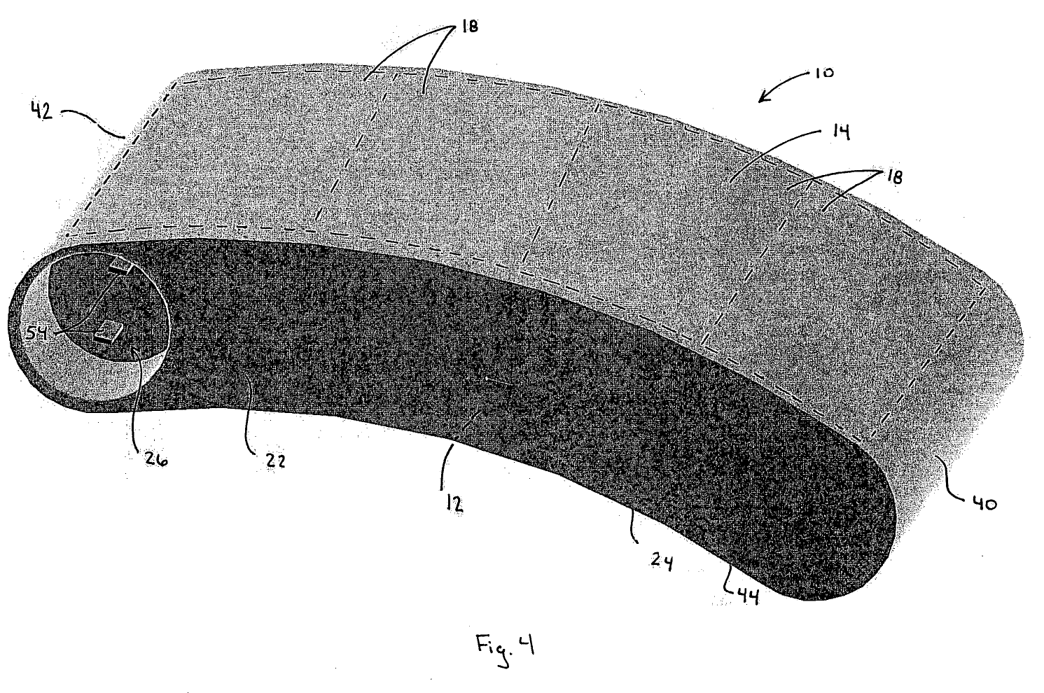

The power source 10 has a single source for electrical power or it may be a plurality of sources for electrical power electrically connected together. For example, the source for electrical power may be a single battery 16, as depicted in FIG. 1, or a plurality of batteries 18 electrically connected together, as depicted in FIG. 4. The battery 16, or batteries 18, may be rechargeable or non-rechargeable.

Referring back to FIG. 2, the power source 10 has an upper surface 20 and a lower surface 22 bounded by the first and second curvilinear sides 12, 14. Preferably, the upper and lower surfaces 20, 22 are substantially planar, but have a curvilinear perimeter 24.

In a preferred embodiment, an electrical connector 26, described in more detail below, is located within the lower surface 22. It is well within the scope of the present invention, however, to located the electrical connector 26 anywhere, including on the lower surface 22, on a side of the power source 12, 14 or on the upper surface 20.

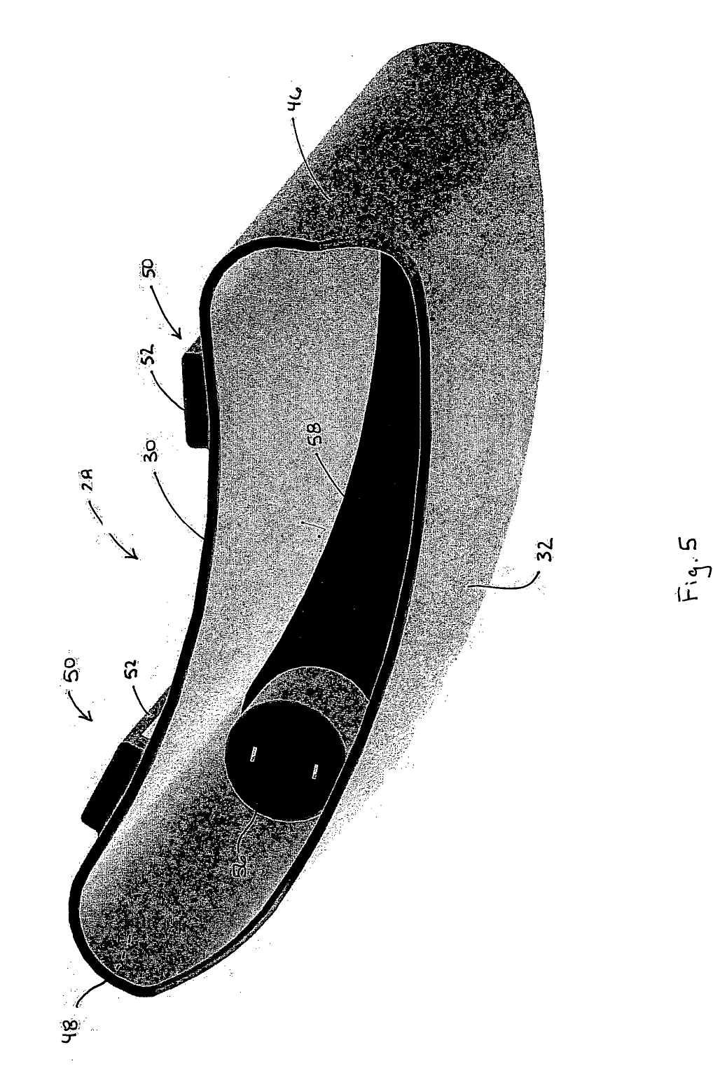

A power source compartment 28, as depicted in FIGS. 2 and 5, is provided for locating and removably securing the power source 10 at least partially therein. The compartment 28 has a first curvilinear portion 30 having a complementary shape to the first curvilinear side 12 of the power source 10. Similarly, the compartment 28 has a second curvilinear portion 32 having a complementary shape to the second curvilinear side 14 of the power source 10.

In the alternative embodiment where only the first curvilinear side 12 of the power source 10 is concave, the power source compartment 28 will have the first curvilinear portion 30 in a complementary shape.

Although the preferred embodiment depicted in the figures shows a substantially solid first and second curvilinear portions 30, 32, it should be readily understood that those portions 30, 32 can also be slotted or ported with any number of slots or ports or any slot or port design, combination or orientation.

In a preferred embodiment, the first curvilinear portion 30 of the power source compartment 28 has a first height 34 and the second curvilinear portion 32 has a second height 36, as best seen in FIG. 2. Preferably, the second height 36 is less than the first height 54, thereby allowing at least a portion 38 of the power source 10 seated in the compartment 28 to be exposed. This design allows the power source 10 to be grasped and removed from the compartment 28 or inserted into the compartment 28 as the case may be.

Those skilled in the art will readily understand that the first and second heights 34, 36 can be equal or oriented so that the second height 56 is greater than the first height 34. Additionally, the power source compartment 28 can be equipped with a cover (not shown). The cover can partially, or fully, cover the power source compartment 28 and the power source 10 therein. The cover can be completely removed or it can be attached to the compartment 28 by one or more hinges, snaps, latches, male/female couplings, bolts, screws, friction fittings, magnets, combinations thereof or any other mechanical fastener known to those skilled in the art.

As shown in FIGS. 1, 2 and 4, the first and second curvilinear sides 12, 14 of the power source 10 are preferably connected together with first and second curvilinear end sections 40, 42. In a preferred embodiment, the first and second curvilinear sides 12, 14 are greater in length than the length of the end sections 40, 42. This design results in the power source 10 being longer than it is wide, however, those skilled in the art will appreciate that the power source 10 can be wider than it is long or having an equal width and length without departing from the scope of the invention.

The first and second curvilinear sides 12, 14, the first and second curvilinear end sections 40, 42 and the upper and lower surfaces 20, 22 preferably comprise a shell 44 for the power source 10.

The first and second curvilinear portions 30, 32 of the power source compartment 28 are preferably connected together with first and second curvilinear end portions 46, 48. Preferably, the end portions 46, 48 have a complementary shape to the first and second end sections 40, 42 of the power source 10. In a preferred embodiment, the first and second curvilinear sides 12, 14 are greater in length than the length of the end sections 40, 42. This design allows the power source compartment 28 to have an overall complementary shape to the power source 10.

Referring now to FIGS. 2 and 5, at least one attachment means 50 for securing the power source compartment 28 to a belt, or strap, (not shown) is provided. In the preferred embodiment, the means 50 includes two substantially identical clips 52. The clips 52 attach to the second curvilinear portion 32. Other means include but, not are limited to, male/female couplings, clamps, snaps, latches, friction fittings, screws, bolts, rivets, magnets and combinations thereof may also be used without departing from the scope of the invention. Those skilled in the art will understand that the attachment means 50 can be located on any surface of the power source compartment 28.

Those skilled in the art will also appreciate that the attachment means 50 can be located directly on any surface of the power source 10. In a preferred embodiment (not shown), the clips 52 can be attached to the first curvilinear side 12 so that the power source 10 can be clipped to a belt and directly conform to the hip area 15 of the wearer.

As shown in FIGS. 1 and 4, the electrical connector 26 on the lower surface 22 of the power source 10 is preferably a recessed, male electrical connector 54. A complementary shaped, upwardly extending female electrical connector 56 is located in the base 58 of the power source compartment 28. Locating the power source 10 into the power source compartment 28 aligns the male and female electrical connectors 54, 56. Further engagement of the power source 10 and the power source compartment 28 electrically connects the male and female electrical connectors 54, 56.

Those skilled in the art will readily understand that the power source 10 can be fitted with the female electrical connector 56 and the power source compartment 28 can be fitted with the male electrical connector 54. Other electrical connectors known to those skilled in the art, such as electrical contacts, tabs and/or wires may also be used.

As seen in FIG. 2, at least one wire 60 from the electrical connector 56 in the base 58 of the power source compartment 28 supplies electrical power to one or more electrically operated devices. The wire 60 can also be used to deliver electrical power to the power source 10 to charge the power source 10.

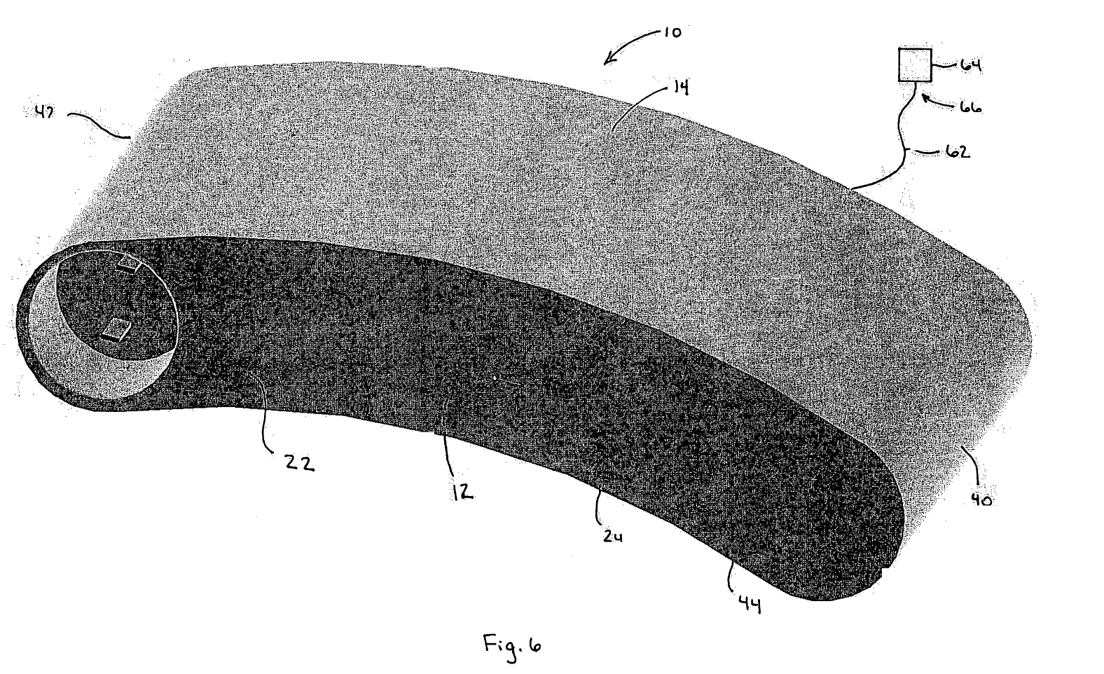

In an alternative embodiment depicted in FIG. 6, the power source 10 may have at least one electrically connected wire 62 extending therefrom. The wire 62 has a quick connect connector 64 attached to an end 66 thereof for attachment to a complementary connector (not shown). The wire 62 can extend from any portion of the power source 10, but preferably it extends from the upper surface 20. The wire 62 is adapted to transmit and receive electrical power to and from the power source 10.

A method for locating the power source 10 in the power source compartment 28 will now be described. The above described power source 10 and the power source compartment 28 are provided. The power source 10 and/or the power source compartment 28 are aligned so that the first and second curvilinear sides 12, 14 of the power source 10 align with the first and second curvilinear portions 30, 32 of the power source compartment 28. The alignment may be accomplished by manual or automatic means. The power source 10 is then inserted into the compartment 28. Locating the power source 10 into the compartment 28 in this manner locates the above-described male and female electrical connectors 54, 56 proximate one another. Further engagement of the power source 10 into the compartment 28 causes the male and female electrical connectors 54, 56 to electrically connect.

The power source compartment 28 is located on a belt or strap as described above. The power source 10 may be inserted into the power source compartment 28 before or after the belt is put on by the operator. Regardless of when the power source 10 is inserted into the power source compartment 28, at least the compartment 28 and preferably both the compartment 28 and the power source 10, substantially conform to the shape of the hip, or waist, area 15 of a wearer.

In accordance with the provisions of the patent statutes, the present invention has been described in what is considered to represent its preferred embodiments. However, it should be noted that the invention can be practiced otherwise than as specifically illustrated and described without departing from its spirit or scope.

1. A power source, comprising:
a shell having a plurality of exterior surfaces wherein at least one of said surfaces is a concave surface having a complementary shape to the hip area of a wearer; and
at least one rechargeable battery disposed within an interior portion of said shell.

2. The power source of claim 1, wherein said shell has an inner concave surface and an outer concave surface, said inner and said outer concave surfaces are disposed vertically parallel but apart from each other.

3. The power source of claim 1, wherein said inner concave surface and said outer concave surface are joined by a first curvilinear end portion and a second curvilinear end portion.

4. The power source of claim 1, wherein at least one electrical connector is exposed through at least one of said plurality of exterior surfaces and is in electrical communication with said at least one rechargeable battery.

5. A power source, comprising:
a first concave surface and a second concave surface wherein said first and said second concave surfaces are oriented substantially parallel to one another; and
a source for electrical power disposed within said first and said second concave surfaces.

6. The power source of claim 5, wherein said first concave surface has an upper portion and said second concave surface has an upper portion, and said first concave upper portion and said second concave upper portion are connected together with an upper surface.

7. The power source of claim 6, wherein said first concave surface has a lower portion and said second concave surface has a lower portion, and said first concave lower portion and said second concave lower portion are connected together with an lower surface.

8. The power source of claim 7, wherein said upper surface and said lower surface are substantially planar.

9. The power source of claim 8, wherein said upper surface, said lower surface, said first concave surface and said second concave surface are bounded by a first curvilinear side and a second curvilinear side.

10. The power source of claim 7, wherein said lower surface has at least one electrical connector.

11. The power source of claim 5, wherein at least one of said first or said second concave surfaces conforms to the hip area of a wearer.

12. The power source of claim 5, wherein said source for electrical power comprises at least one battery.

13. The power source of claim 12, wherein said source for electrical power comprises at least one rechargeable battery.
